(19) United States
(12) Patent Application Publication
(10) Pub. No.: US 2005/0023888 A1
(43) Pub. Date: Feb. 3, 2005

(54) Control device for brake systems

(75) Inventor: David J. Knight, Westlake, OH (US)

Correspondence Address: CALFEE HALTER & GRISWOLD, LLP, 800 SUPERIOR AVENUE, SUITE 1400, CLEVELAND, OH, 44114, US

(73) Assignee: Bendix Commercial Vehicle System, LLC, Westlake, OH (US)

(21) Appl. No.: 10/897,690

(22) Filed: Jul. 23, 2004

Related U.S. Application Data
(60) Provisional application No. 60/489,879, filed on Jul. 24, 2003.

(51) Int. Cl. B60T 13/00

(52) U.S. Cl. 303/7

(57) ABSTRACT

A space-saving valve assembly for use with brake systems that utilize compressed or pressurized air to apply or release a vehicle's brakes. This “button within a button” device includes a first control for operating a first portion of a brake system and a second control for operating a second portion of the brake system. The first control includes a body, similar to known “push-pull” type buttons or controls, which defines an aperture that runs entirely through length of the body. The second control includes a body and handle that are concentrically disposed within the aperture of the first control. Each button is attached to a different component or subsystem of a vehicle's brake system and controls, independent of the other button, the operation of the subsystem to which it is connected.

### CROSS-REFERENCE TO RELATED APPLICATIONS

This patent application claims the benefit of U.S. Provisional Patent Application Ser. No. 60/489,879 filed on Jul. 24, 2003 and entitled “Tractor/Trailer Park Control,” the disclosure of which is incorporated by reference as if fully rewritten herein.

### STATEMENT REGARDING FEDERALLY FUNDED RESEARCH

This invention was not made by an agency of the U.S. Government nor under contract with an agency of the United States Government.

### TECHNICAL FIELD OF THE INVENTION

The present invention relates generally to control devices for use with brake systems on motor vehicles, and more specifically to a multifunctional control device for use with the air brake systems of heavy commercial vehicles such as combination vehicles having both a tractor portion and a trailer portion.

### BACKGROUND OF THE INVENTION

Large commercial combination vehicles that include a tractor portion and a trailer portion typically include a braking system that utilizes compressed air. Prior art air brake systems usually include a combination of three different braking systems, namely: the service brakes, the parking brakes, and the emergency brakes. The service brake system applies and releases the brakes when the driver uses the brake pedal during normal driving situations. The parking brake system applies and releases the parking brakes when the parking brake control is engaged. The emergency brake system utilizes portions of the service brake and parking brake systems to stop the vehicle in the event of a brake system failure.

The air brake systems installed on large commercial vehicles such as trucks, tractor/trailer combinations, and buses typically utilize mechanically operated pneumatic push-pull control valves for operating the vehicle's parking brakes and controlling the “supply” line to the trailer service brakes. Federal Motor Vehicle Safety Standard (FMVSS) No. 121 requires that these parking brake controls and the trailer brake controls be located in close proximity to the operator of the vehicle. Given the current state of the art, compliance with this rule necessitates the installation of large pneumatic push-pull valves, pneumatic line, and connectors in the vehicle's instrument panel. The pneumatic push-pull valves are typically arranged side-by-side, resulting in a valve assembly that is bulky and that reduces the space in the instrument panel that is available for other desired instruments and devices. Loss of this physical space may result in other buttons or controls being located less conveniently or may result in a dash configuration that is crowded or generally inefficient. Thus, there is a need for a brake valve assembly configuration that conserves space in a vehicle's instrument panel while preserving all desired brake system functionality.

### SUMMARY OF THE INVENTION

These and other deficiencies of the prior art are overcome by the present invention, the exemplary embodiment of which provides a space-saving valve assembly for use with brake systems, and particularly with brake systems that utilize compressed or pressurized air to apply or release a vehicle's brakes. More specifically, the present invention provides a convenient and multi-functional “button within a button” control device that includes a first control or control means for operating a first portion of a brake system and a second control or control means for operating a second portion of the brake system. In the exemplary embodiment, the first control means includes a body, similar to known “push-pull” type controls, that defines an aperture that runs entirely through length of the body. The second control means includes a body and handle that are concentrically disposed within the aperture of the first control means. Each button or control means is attached to a different component or subsystem of a vehicle's brake system and controls, independent of the other button, the operation of the subsystem to which it is connected.

In the exemplary embodiment, the air brake system operated by the present invention includes both the vehicle's parking and emergency brakes. The first control means is connected to the trailer air supply or emergency brakes and the second control means is attached to the tractor air supply or parking brakes. The control device of this invention includes four possible positional combinations, wherein the buttons are both depressed, both extended, or one button is depressed while the other is extended. Thus, the vehicle's operator may control more than one brake subsystem with a single multifunctional device.

Further advantages of the present invention will become apparent to those of ordinary skill in the art upon reading and understanding the following detailed description of the preferred embodiments.

### BRIEF DESCRIPTION OF THE DRAWINGS

The accompanying drawings, which are incorporated into and form a part of the specification, schematically illustrate one or more exemplary embodiments of the invention and, together with the general description given above and detailed description of the preferred embodiments given below, serve to explain the principles of the invention.

FIGS. 1A-D are cross sectional views of the exemplary embodiment of the multifunctional control device of the present invention in each of the device's four possible operational positions.

FIGS. 2A-D are top perspective views of the exemplary embodiment of the multifunctional control device of the present invention in each of the devices's four possible operational positions.

FIG. 3 is a top view of the exemplary embodiment of the multifunctional control device of the present invention showing one possible geometric configuration of the “button within a button.”

### DETAILED DESCRIPTION OF THE INVENTION

The present invention provides a valve assembly that is useful for controlling portions of a vehicle's air brake system when properly attached to such a system using means known to those skilled in the art. The exemplary embodiment shown in the Figures is particularly useful for vehicles having both tractor and trailer portions and includes a dual controller or double button assembly. The dual controller assembly further includes two separate and independent control means or devices, one mounted, disposed, or situated concentrically within the other. This brake system control assembly is relatively compact compared to existing valve assemblies and is well suited for mounting on or in a tractor dash or control panel.

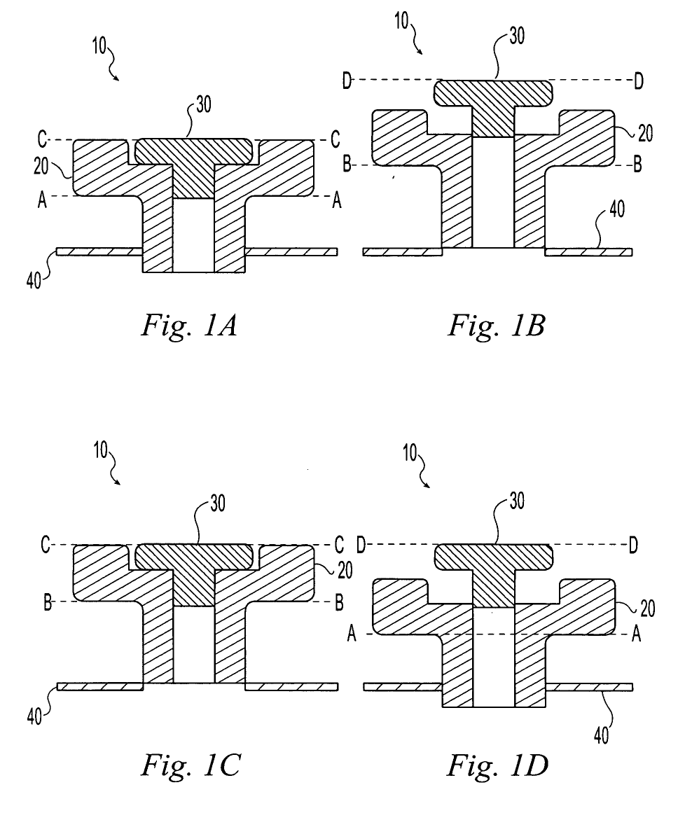

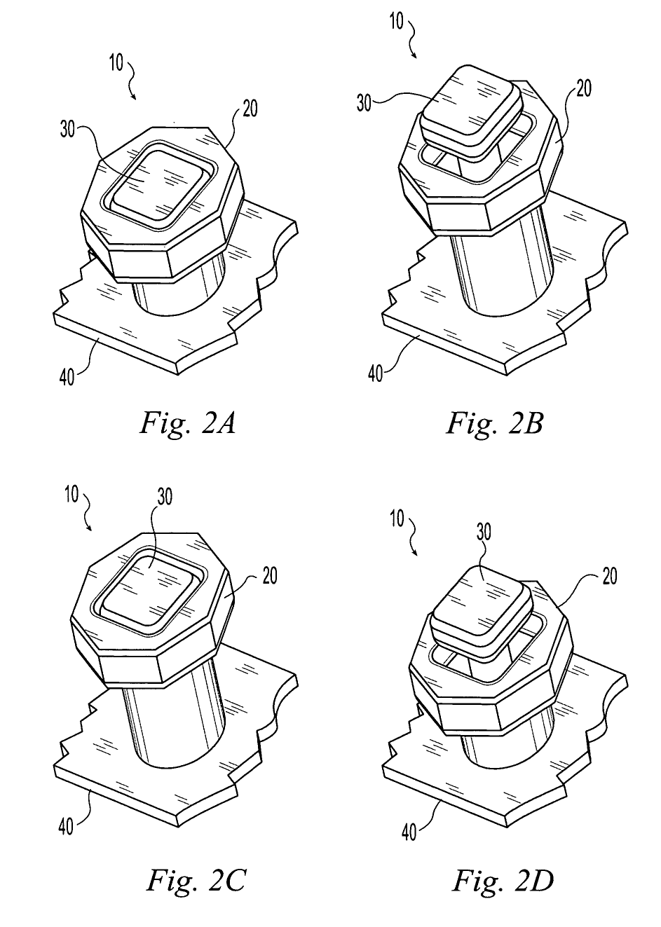

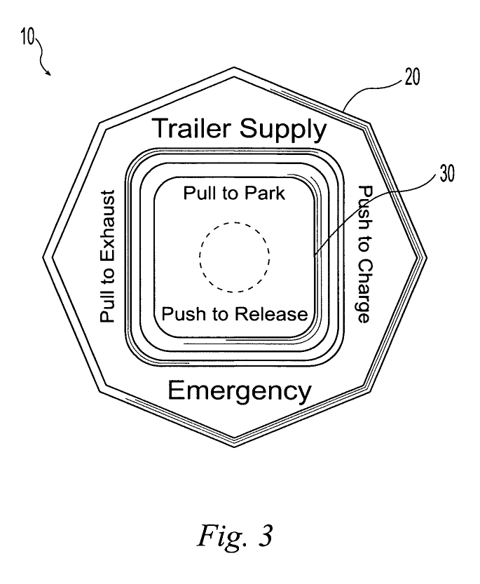

With reference now to the Figures, FIGS. 1-3 show an exemplary embodiment of the present invention that is configured to control a vehicle's parking and emergency brakes. As best shown in FIGS. 1A-D and 2A-D, dual controller 10 provides a first control 20 for controlling the supply of pressurized air to brakes on the vehicle's trailer portion and a second control 30 for controlling the supply of pressurized air to the parking brakes on the vehicle's tractor portion. In the exemplary embodiment, the body of each control includes a shaft portion and a handle or “button” portion. The shaft portions are typically cylindrical in shape, although other geometries are possible. The shape of the handle portions may be substantially circular, square, rectangular, hexagonal, octagonal, or other industry-accepted combinations thereof (see, for example, FIG. 3).

As shown in the Figures, second control 30 is physically smaller than first control 20 and is mounted within an aperture or bore formed within the body of first control 20. In one embodiment of this invention, the entire dual controller is mounted within a mounting body 40, which forms part of the controller assembly. Mounting body 40 may be a metal or plastic plate or panel. In another embodiment, the mounting body may simply be a mounting surface which includes portion of the surface of a vehicle's control panel or dashboard that has been adapted to receive the dual controller.

In the embodiment shown in the Figures, each control is moveable in a direction that is generally perpendicular to the mounting body or mounting surface. Each control, independent of the other control, is positionable between a brake applied position and a brake released position depending on the situation encountered by the vehicle's operator. Thus, the relative positions of the controls with respect to both the control panel or dash and each other determine the braking configuration or state of the tractor and trailer. Essentially, the dual controller of the present invention provides two, and in other embodiments more than two, “on-off” system controls, one situated within the body of the other.

As shown in the exemplary embodiment of FIGS. 1A-D and 2A-D, there are four possible positions for the individual controls when in operation. In FIG. 1A, the two controls are both depressed or “pushed in” relative to mounting body 40 and relative to one another as indicated by line A, the depressed position for first control 20, and line C, the depressed position for second control 30. In FIG. 1B, the two controls are both extended or “pulled out” relative to mounting body 40 and relative to one another as indicated by line B, the extended position for first control 20, and line D, the extended position for second control 30. In FIG. 1C, first control 20 is shown the extended position while second control 30 is shown in the depressed position and in FIG. 1D, first control 20 is shown in the depressed position and second control 30 is shown in the extended position.

Numerous combinations for applying or releasing the tractor and trailer brakes or park and emergency brakes are possible with the dual controller of the present invention and the device may be configured in different ways to meet different system, vehicle, or operator demands. However, for the purpose of providing a working example, in the exemplary embodiment shown in the Figures, the emergency or trailer brakes are (i) applied by extending first control 20 to position B; and (ii) released by depressing the control to position A. Likewise, the parking or tractor brakes are applied (i) by extending second control 30 to position D; and (ii) released by depressing control 30 to position C. Extending both controls simultaneously applies both the tractor and trailer brake systems, and depressing both controls simultaneously releases both the tractor and trailer brake systems. Thus, each brake system can be controlled independently of the other brake system or can be controlled simultaneously with the other brake system.

The dual controller or control device of the present invention made be manufactured, assembled, and installed using various techniques and methods known in the art. The present invention is compatible with a wide array of brake control modules, including commercially available brake control modules such as the MV-1, MV-2, or MV-3 brake modules available from Bendix Commercial Vehicle Systems (Elyria, Ohio).

While the above description contains much specificity, this should not be construed as a limitation on the scope of the invention, but rather as an exemplification of certain preferred or exemplary embodiments. Numerous other variations of the present invention are possible, and it is not intended herein to mention all of the possible equivalent forms or ramifications of this invention. Various changes may be made to the present invention without departing from the scope or spirit of the invention.

1. A valve assembly for use with a vehicle's brake system, comprising:
(a) a first control means for operating a first portion of said brake system, said first control means further comprising a body, and wherein said body further comprises an aperture extending lengthwise though said body; and
(b) a second control means for operating a second portion of said brake system, and wherein said second control means is disposed within said aperture in said body and functions independently of said first control means.

2. The valve assembly of claim 1, wherein said brake system further comprises air brakes, and wherein said air brakes further comprise emergency brakes and parking brakes.

3. The valve assembly of claim 2, wherein said first portion of said brake system comprises said emergency brakes and said second portion of said brake system further comprises said parking brakes.

4. The valve assembly of claim 2, wherein said first portion of said brake system comprises said parking brakes and said second portion of said brake system further comprises said emergency brakes.

5. The valve assembly of claim 1, wherein said second control means is concentrically disposed within said first control means.

6. A device for operating a vehicle's air brake system, comprising:
(a) a mounting body; and
(b) a dual controller mountable within said mounting body, and wherein said dual control further comprises:
(i) a first control for operating a first portion of said brake system, said first control further comprising a body, and wherein said body further comprises an aperture extending lengthwise though said body; and
(ii) a second control for operating a second portion of said brake system, and wherein said second control is concentrically disposed within said aperture in said body and functions independently of said first control.

7. The device of claim 6, wherein said air brake system further comprises emergency brakes and parking brakes.

8. The device of claim 7, wherein said first portion of said air brake system comprises said emergency brakes and said second portion of said brake system further comprises said parking brakes.

9. The device of claim 7, wherein said first portion of said brake system comprises said parking brakes and said second portion of said brake system further comprises said emergency brakes.

10. The device of 6, wherein said mounting body further comprises a panel, base, dashboard, or combinations thereof.

11. A system for operating the air brakes of a vehicle having a tractor portion and a trailer portion, said system comprising a dash-mountable valve assembly, and wherein said valve assembly further comprises:
(a) a mounting body;
(b) a trailer control, said trailer control further comprising a shaft portion and a handle portion, and wherein said trailer control is supported by said mounting body and is positionable between a released position and an applied position, and wherein said trailer control includes an aperture extending through said shaft portion and said handle portion; and
(c) a truck control, wherein said truck control further comprises a shaft portion and a handle portion, and wherein said truck control is supported by said mounting body and is positionable between a released position and an applied position, and wherein said truck control is disposed within said aperture in said trailer control.

12. The system of claim 11, wherein said truck control is concentrically disposed within said trailer control.

13. The system of claim 11, wherein said trailer control and said tractor control further comprise two independent controls, and wherein each control is independently positionable between said released and said applied positions.

14. The system of claim 11, wherein said controls are moveable in a direction generally perpendicular to said mounting body.

15. A method for conserving space in the control panel of a vehicle utilizing a manually controlled valve assembly for operating said vehicle's air brake system, said method comprising the steps of:
(a) mounting a first control for operating a first portion of said brake system within a second control for operating a second portion of said brake system; and
(b) mounting said controls in said control panel.

16. The method of claim 15, wherein said air brake system further comprises emergency brakes and parking brakes, and wherein said controls, independent of one another, operate said emergency brakes and said parking brakes.

17. The method of claim 16, wherein said first portion of said brake system comprises said emergency brakes and said second portion of said brake system further comprises said parking brakes.

18. The valve assembly of claim 16, wherein said first portion of said brake system comprises said parking brakes and said second portion of said brake system further comprises said emergency brakes.
